(19) United States
(12) Patent Application Publication
(10) Pub. No.: US 2007/0271151 A1
(43) Pub. Date: Nov. 22, 2007

(54) Method for auctioning and video advertising

(75) Inventors: Pedro J. Torres, Chuano (VE); Pedro M. Torres, Chuano (VE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Baninvest Banco de Investment Corporation of Panama, Chuano (VE)

(21) Appl. No.: 11/439,008

(22) Filed: May 22, 2006

(51) Int. Cl. G06Q 30/00

(52) U.S. Cl. 705/26

(57) ABSTRACT

A sales website, such as an auction site, can utilize additional features to enhance the operation of such a website as well as attract buyers and sellers. According to one embodiment, a video advertisement feature can be utilized to advertise an article on an auction website. In addition, video conferencing capabilities can be added to an auction site, for example, to increase the capability of such sites. Furthermore, popular videos can be displayed at an auction site or sales site to provide entertainment value.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND

Embodiments of the present invention relate to video advertising, especially for use via an auction site. Internet auction sites have recently grown in popularity with the success of companies such as eBay that allow users to offer goods for sale to prospective bidders. However, only a limited amount of information can be conveyed via these auction sites to the consumer. The consumer or potential bidder is, thus, essentially required to bid without a full knowledge of a product's capabilities, history, or other useful information.

Also, some websites offer products for sale via their websites or via an auction site with no easy way for the potential bidder or purchaser to contact the seller. While the seller may provide an e-mail address, this is typically insufficient for the prospective buyer to efficiently negotiate a price for the item or easily obtain additional information about an article.

Also, with the competition between websites to attract potential customers, there is a need for additional advertising techniques to entice such customers to a particular website. Furthermore, there is a need for an advertising technique that would entertain customers when they visit such a site.

### BRIEF SUMMARY

One embodiment addresses at least one of these needs by providing an auction site accessible via a computer network; offering an article for auction via the auction site; receiving from a seller of the article a video for the article; and providing access to the video via the auction site so as to enable a prospective bidder to access the video for viewing

Another embodiment addresses another of these needs by providing an auction site accessible via a computer network; offering an article for auction via the auction site; receiving from a seller of the article a video for the article; providing access to the video via the auction site so as to enable a prospective bidder to access the video for viewing; and soliciting feedback from the prospective bidder on the video.

Still another embodiment addresses at least one of these needs by providing an auction site accessible via a computer network; offering an article for auction via the auction site; receiving from a seller of the article a video for the article; providing access to the video via the auction site so as to enable prospective bidder to access the video for viewing; and configuring an icon as part of the auction site to allow the prospective bidder to conduct a video conference with the seller.

Further embodiments will be apparent to those of ordinary skill in the art from a consideration of the following description taken in conjunction with the accompanying drawings, wherein certain methods, apparatuses, and articles of manufacture for practicing the embodiments of the invention are illustrated. However, it is to be understood that the invention is not limited to the details disclosed, but includes all such variations and modifications as fall within the spirit of the invention and scope of the claims.

### BRIEF DESCRIPTION OF THE DRAWINGS

FIG. 1 is a block diagram illustrating a screen display for an auction site according to one embodiment of the invention.

FIG. 2 is a block diagram illustrating a computer network for communication between buyers and sellers, according to one embodiment of the invention.

FIG. 3 is a functional block diagram of a computerized device for use in implementing the devices shown in FIG. 2, according to one embodiment of the invention.

FIG. 4 is a flow chart illustrating a method of auctioning an article according to one embodiment of the invention.

FIGS. 5A and 5B are a flow chart demonstrating a method of auctioning an article according to one embodiment of the invention.

FIG. 6 is a flow chart illustrating a method of soliciting feedback on videos according to one embodiment of the invention.

FIGS. 7A and 7B are a flow chart illustrating a method of ranking videos by popularity according to one embodiment of the invention.

FIG. 8 is a flow chart illustrating a method of conducting a video conference through a sales website according to one embodiment of the invention.

FIGS. 9A and 9B are a flow chart demonstrating a method of conducting a video conference via a sales website according to one embodiment of the invention.

### DETAILED DESCRIPTION

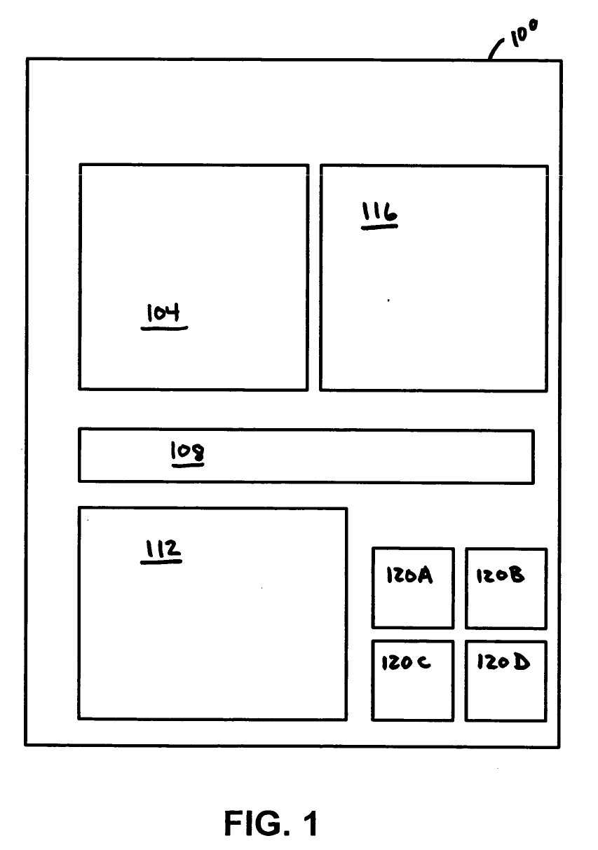

Referring now to FIG. 1, a display 100 of an auction site is shown. The display shows a portion 104 in which a photograph of an item offered for sale can be shown. Section 108 provides a space for a written description of the item being offered for sale. Section 112 provides space in the display for bidding information, such as a list of recent bids and time left for bidding to take place. Section 116 provides an additional feature in that it allows a user to provide a video of the article being sold, in particular, a homemade video that allows the user to advertise the article being sold. Use of such videos, especially homemade videos, via an auction site has not been used in the past. It provides a new avenue for a seller to display his or her goods in a manner that reflects the use or history of a particular item. Furthermore, it encourages people to utilize a particular auction system if they enjoy making videos of their particular products. Furthermore, it provides an entertaining aspect to the sales process in that potential bidders will not only appreciate the additional information that can be obtained about a product through the videos, but also the entertainment value of the videos in and of themselves.

Blocks 120a, 120b, 120c, and 120d illustrate a portion of the display that can be utilized for providing access to additional videos for other articles being sold. This portion of the display can be utilized in a variety of ways. One could play all of the videos at the same time or merely show a freeze frame version of the videos and allow the user to select one of the videos for display. This allows popular videos to be displayed to the user so that the user can choose one of the popular videos to watch.

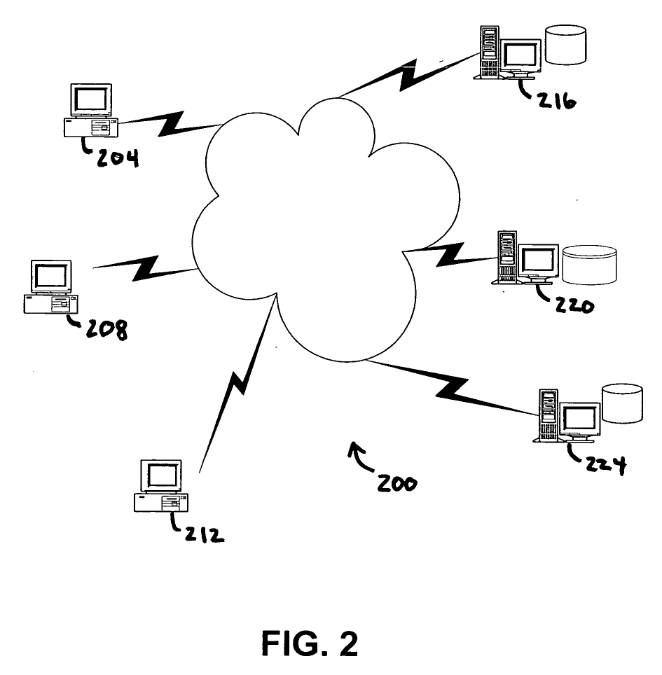

FIG. 2 illustrates a system for implementing a sales system, such as an auction system. FIG. 2 shows system 200 having seller computers 204, 208, and 212 in communication with an auction computer 216. In addition, potential buyer computers 220 and 224 can also communicate with the auction system 216 or, alternatively, with the seller computers. Computer network 230 can be utilized to facilitate the communication.

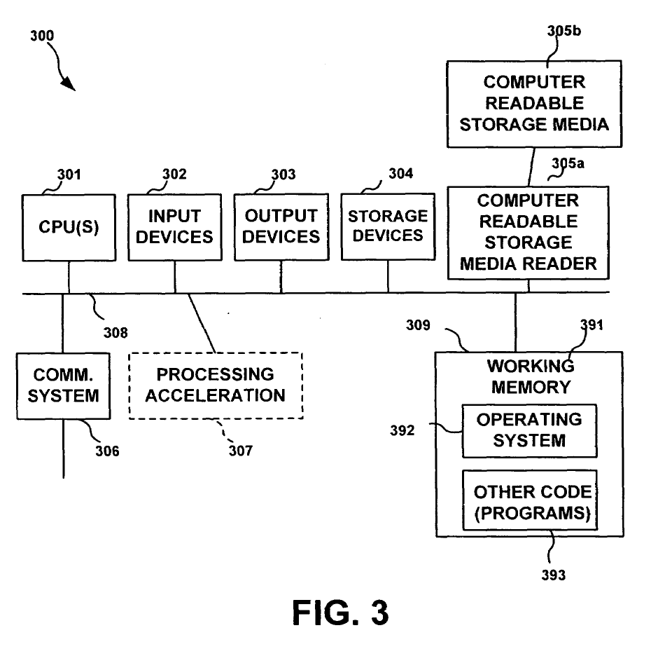

FIG. 3 illustrates a block diagram of a computerized device that can be utilized to implement the elements shown in FIG. 2. FIG. 3 broadly illustrates how individual system elements can be implemented. System 300 is shown comprised of hardware elements that are electrically coupled via bus 308, including a processor 301, input device 302, output device 303, storage device 304, computer-readable storage media reader 305a, communications system 306 processing acceleration (e.g., DSP or special-purpose processors) 307 and memory 309. Computer-readable storage media reader 305a is further coupled to computer-readable storage media 305b, the combination comprehensively representing remote, local, fixed and/or removable storage devices plus storage media, memory, etc. for temporarily and/or more permanently containing computer-readable information, which can include storage device 304, memory 309 and/or any other such accessible system 300 resource. System 300 also comprises software elements (shown as being currently located within working memory 391) including an operating system 392 and other code 393, such as programs, applets, data and the like.

System 300 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 300 component (e.g. within communications system 306). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) Not all system 300 components will necessarily be required in all cases.

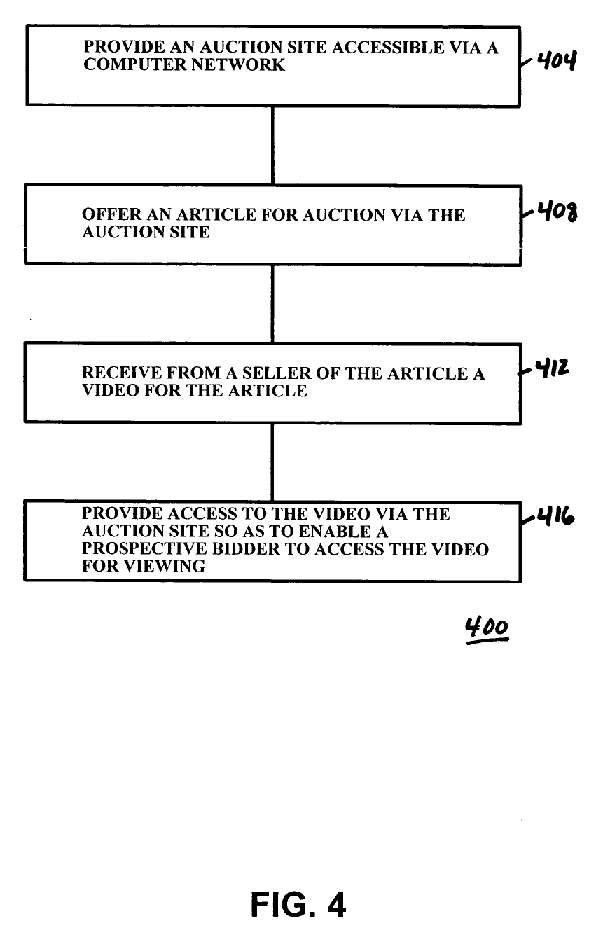

Referring now to FIG. 4, a flow chart 400 demonstrating a method of utilizing videos to enhance a web site, such as a computer auction site, can be seen. In block 404, the flow chart shows that an auction site is provided that is accessible to sellers and prospective buyers via a computer network. In block 408, a seller provides an article that can be auctioned, for example, via the auction site. In block 412, a video is submitted for the article being sold and this video is received from the seller for use on the auction site. In block 416, access is provided to the video via the auction site so as to enable a prospective bidder to access the video for viewing.

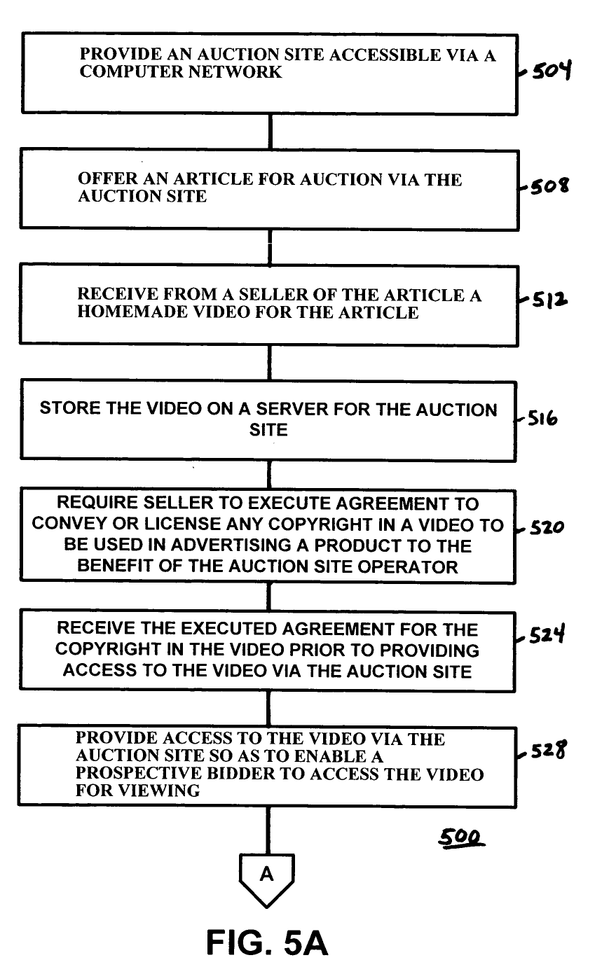

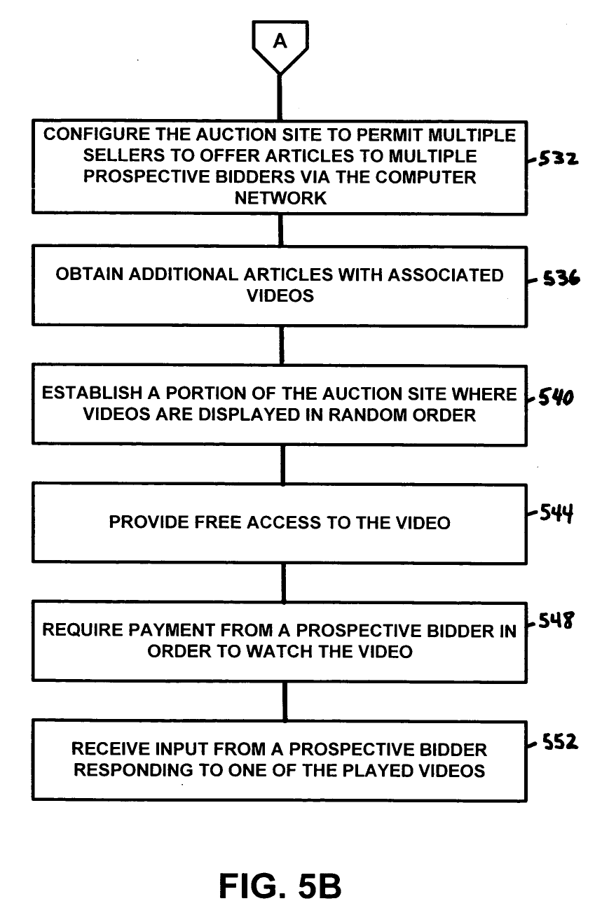

A more detailed example of this method shown in FIG. 4 can be seen in FIGS. 5A and 5B. In flow chart 500, block 504 shows that an auction site is provided that is accessible via a computer network. An article can then be offered for auction via the auction site, as shown in block 508. Furthermore, a seller can submit a homemade video for the article, as shown in block 512. This video can be stored on a server, such as server 216 in FIG. 2, for the auction site, as shown in block 516.

Since videos are subject to copyright protection, the auction site can require the submitter of the video to convey or license any necessary copyright right for the video to the benefit of the auction site operator. Even if the conveyance or license is not made directly to the operator of the auction site, it can be drafted to give permission to the auction site operator. In block 524, the executed agreement can be provided prior to any access to the video being granted via the auction site. In block 528, access can then be provided to the video via the auction site so as to enable a prospective bidder to view the video.

It is envisioned that videos that are submitted will be homemade videos that a seller makes for the purpose of advertising the article being sold. Thus, the video may be a humorous video intended merely to draw attention to the article being sold. Alternatively, the video may be informational and, thus, provide a history of use of the article or demonstrate the quality of the article.

Furthermore, it is even possible that third parties could submit videos upon seeing articles for sale. The seller of the article could then grant permission for such videos to be associated with the article on the auction site. This would allow those who do not wish to spend the time preparing home videos to still reap the benefits of videos prepared by third parties. Furthermore, it would allow the third parties to showcase their skills in advertising. Thus, there would be a mutual benefit to both the seller and the third party.

Block 532 illustrates that the auction site can be configured to permit multiple sellers to offer articles to multiple prospective bidders via the computer network. Thus, as shown in block 536, additional articles and associated videos can be obtained. In block 540, a portion of the auction site can be established where different videos are displayed. The videos can be arranged as shown in FIG. 1 where blocks 120a, 120b, 120c, and 120d all illustrate potential videos for playback by a bidder. Alternatively, that portion of the display could randomly play videos for different articles being auctioned on the website.

Different fee structure models can be employed to implement the video system. For example, a popular video may attract potential bidders to an auction site and, thus, result in greater profits and use of the auction site. Thus, it is feasible that the provider of the video would be compensated based on how many times potential bidders access a submitted video. Alternatively, a potential bidder could be charged when it selects a video for display. This would provide an additional revenue stream to an auction site by requiring such a bidder to pay a fee to view a video for a specific article. Similarly, such a fee could be charged to watch a random stream of videos or the most popular videos. In addition, a fee could be charged based on the amount of time that videos are watched. Thus, block 544 shows that as a default, free access could be provided to the video. Block 548 shows that payment could be required from a prospective bidder in order to watch the video. Block 552 shows that input can be received from a prospective bidder responding to one of the played videos. Thus, this illustrates that when the random playback of videos or most popular listing of videos is utilized as part of the display, the input received from a prospective bidder can be monitored to compensate the author of those videos and/or direct the prospective bidder to the article listing associated with the selected video.

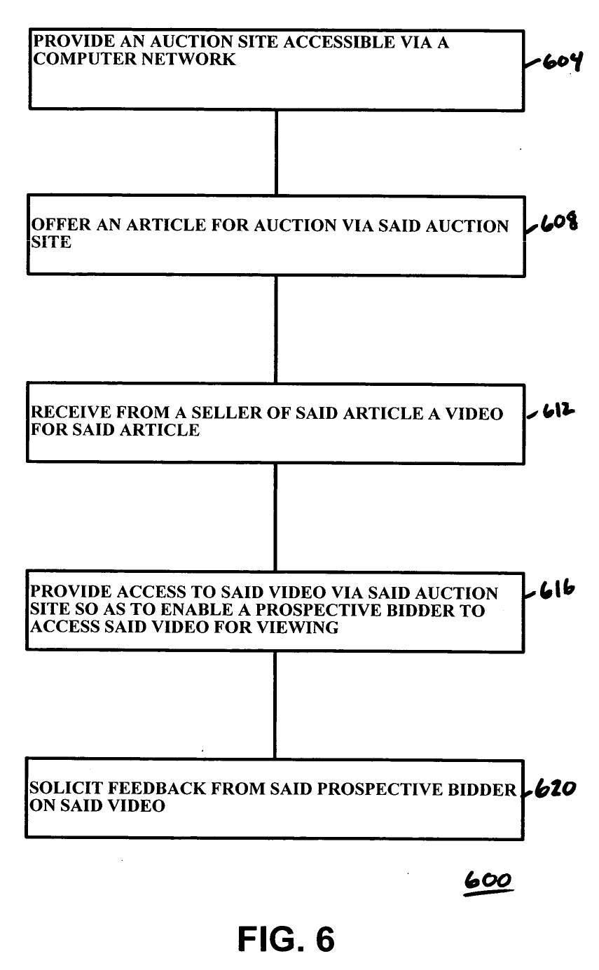

FIG. 6 illustrates another embodiment of the invention which allows a prospective bidder to provide feedback on a video. Namely, FIG. 6 illustrates a flow chart 600 that demonstrates such a method. In block 604, an auction site is provided that is accessible via a computer network. In block 608, an article is offered for auction via the auction site. In block 612, an associated video is received from a seller of the article. Block 616 shows that access can be provided to the video via the auction site so as to enable a prospective bidder to access the video for viewing. Upon viewing the video, feedback can be solicited from the prospective bidder, as shown in block 620. By soliciting feedback from the viewers of the videos, the auction site can rank the most popular videos. Based on the feedback for the videos, the auction site can then determine the most popular videos, the worst videos, the funniest videos, the most informative videos, the videos that would appeal to members of various political parties, etc. Such categories can then be offered to subsequent auction site visitors for their selection.

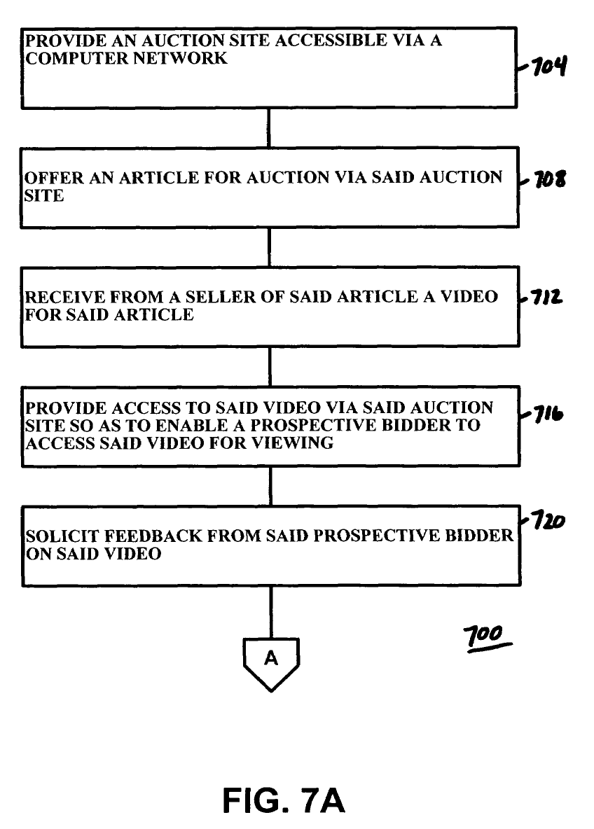

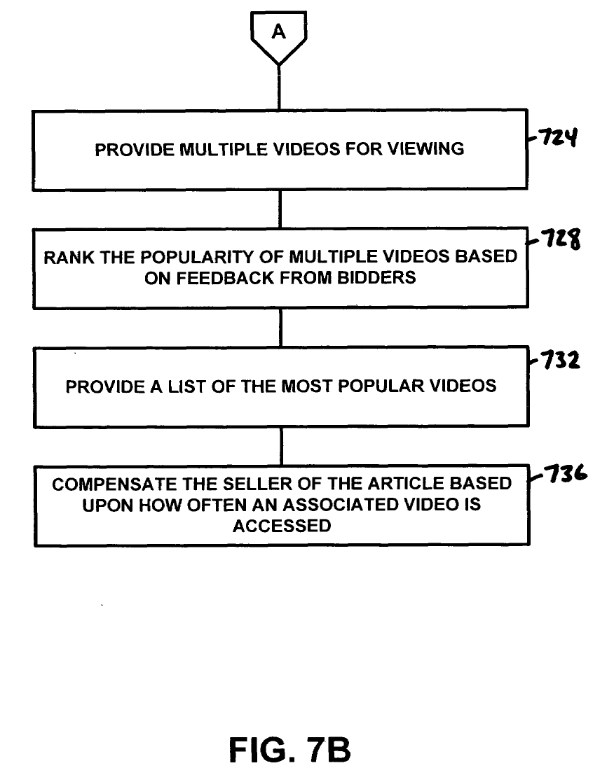

Referring now to FIGS. 7A and 7B, a further example of a video ranking system can be seen. In flow chart 700, block 704 illustrates that an auction site is provided that is accessible via a computer network. In block 708, an article can be offered for auction via the auction site while, in block 712, an associated video can be received from the seller of the article for display on the auction site. In block 716, access can be provided to the video via the auction site, so as to enable a prospective bidder to access and view the video. In block 720, feedback can be solicited from the prospective bidder with regard to the various qualities of the video, such as its informative content, humorous content, high quality, poor quality, political content, family content, adult content, suitability for viewing by children, etc. Furthermore, block 724 emphasizes that multiple videos can be provided for multiple products. In block 728, the feedback from prospective bidders or purchasers can be utilized to rank the popularity of the submitted videos. In block 732, a list for a category of videos can be compiled, such as the most popular videos, the most popular children's videos, the most popular consumer product videos, etc. These videos can then be displayed as shown in FIG. 1 in a variety of manners. For example, the top four as shown in FIG. 1 can be provided in areas 120a, 120b, 120c, and 120d. Alternatively, a listing of the top ten by title can be provided for selection by an auction site visitor. As noted in the discussion of FIG. 5B, the seller of the article can be compensated based on how often a video is accessed, as shown in block 736.

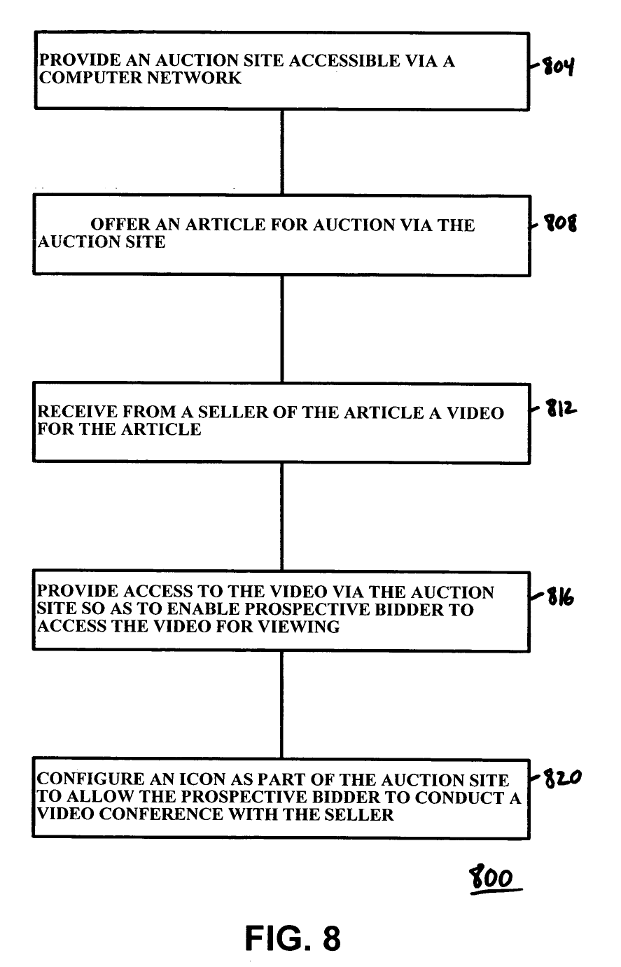

According to another embodiment of the invention, a video conference capability can be added to an auction site. FIG. 8 illustrates a flow chart 800 where block 804 shows that an auction site is made accessible via a computer network. An article can be offered for auction via the auction site in block 808. In block 812, a video for the article can be received from the seller. Access can be provided to the video via the auction site so as to enable a prospective bidder to access and view the video, as shown in block 816. An icon or other selection device can be configured as part of the auction site display to allow the prospective bidder to initiate a video conference with the seller. This is shown in block 820. Such a video conference could be established by configuring the auction site with video conference connection information for a seller and predetermined time periods established with the seller when the seller would be available to conference with prospective bidders. Alternatively, the prospective bidder could submit information for a future teleconference with the seller via the auction site. The video conference could then take place off-line or via the auction site.

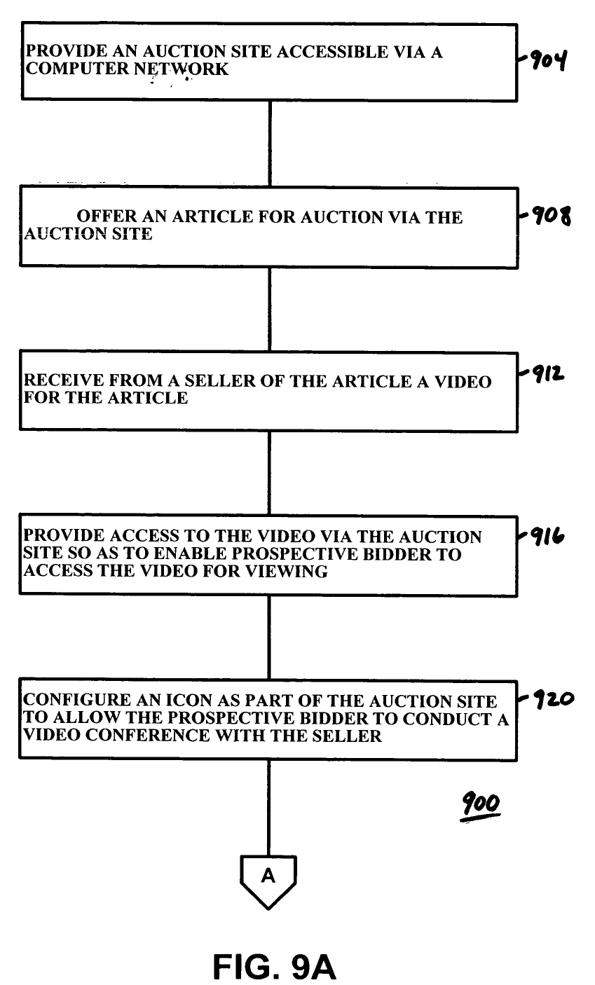

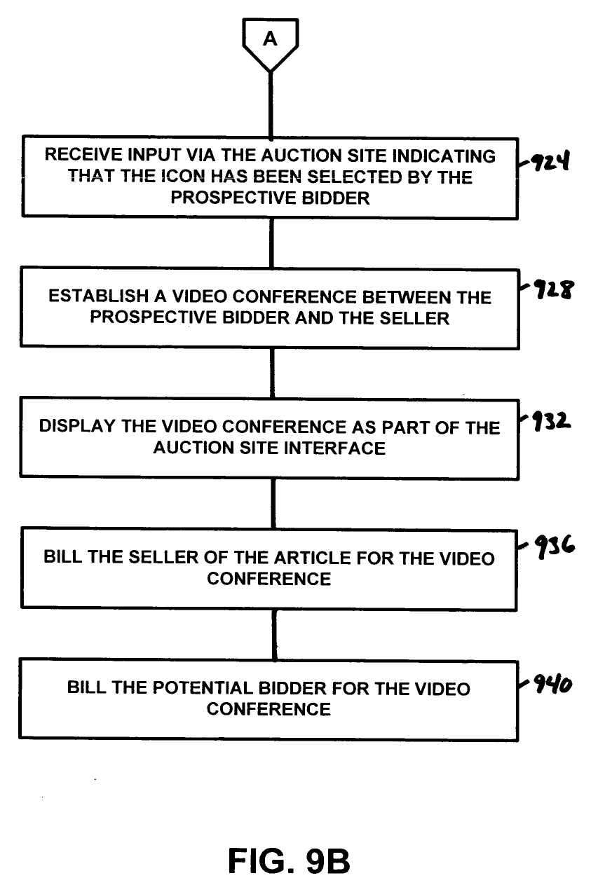

FIGS. 9A and 9B illustrate a flow chart 900 for a video conference system. In block 904, an auction site is provided that is accessible via a computer network. An article can be offered via the auction site, as shown in block 908. A seller can provide a video for the article to the website operator, as shown in block 912. Access can then be provided to the video via the auction site as shown in block 916 so as to enable a prospective purchaser to access the video for viewing. In block 920, an icon or other selection device can be configured as part of the auction site to allow the prospective bidder to conduct a video conference with a seller. The bidder can select the icon, for example, by navigating with a mouse and clicking on the icon. This input can be received by the auction site via the computer network so as to indicate that the icon has been selected by the bidder, as shown in block 924. Assuming the selection takes place when the seller is available for video conferencing, a video conference can immediately be established between the bidder and seller, as shown in block 928. Alternatively, as noted earlier, arrangements can be made to establish a video conference at a later time. In block 932, the display of the auction site can be utilized to display the video conference. Thus, when a bidder selects the video conference option, at least a portion of the display can be utilized for displaying the seller's image.

Because of the enhanced capabilities of the video conference feature, auction sites may choose to charge a fee for use of this capability. A variety of fee structures could be utilized. For example, the seller of the article could be billed by the website operator for video conferences, as shown in block 936. Alternatively, the potential bidder for the article could be billed for the video conference, as shown in block 940. Alternatively, both the seller and bidder could pay a fee to the website operator when a video conference is implemented.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well. Furthermore, the embodiments of the invention may be embodied as code stored in a computer-readable memory of virtually any kind including, without limitation, RAM, ROM, magnetic media, optical media, or magneto-optical media. Even more generally, the embodiments of the invention could be implemented in software, or in hardware, or any combination thereof including, but not limited to, software running on a general purpose processor, microcode, PLAs, or ASICs.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents.

It is thought that the apparatuses and methods of the embodiments of the present invention and its attendant advantages will be understood from this specification. While the above is a complete description of specific embodiments of the invention, the above description should not be taken as limiting the scope of the invention as defined by the claims.

What is claimed is:

1. A computer implemented method of auctioning, said method comprising:
providing an auction site accessible via a computer network;
offering an article for auction via said auction site;
receiving from a seller of said article a video for said article; and
providing access to said video via said auction site so as to enable a prospective bidder to access said video for viewing.

2. The method as claimed in claim 1 wherein said auction site is configured so as to permit a plurality of sellers to offer articles to a plurality of prospective bidders via said computer network.

3. The method as claimed in claim 1 wherein said video is an amateur video made by said seller to increase consumer interest in said article.

4. The method as claimed in claim 3 and further comprising:
requiring said seller to convey or license a copyright right in said amateur video to the benefit of the auction site operator; and
receiving said conveyance or license of said copyright from said seller prior to said providing access to said video via said auction site.

5. The method as claimed in claim 1 and further comprising:
storing said video on a server for said auction site.

6. The method as claimed in claim 1 wherein said providing access to said video comprises:
providing free access to said video.

7. The method as claimed in claim 1 wherein said providing access to said video comprises:
requiring payment from said prospective bidder to enable access to said video by said prospective bidder.

8. The method as claimed in claim 1 and further comprising concurrently displaying via a web page a photo of said article, a description of said article, current bids for said article, and said video for said article.

9. The method as claimed in claim 1 and further comprising:
obtaining a plurality of videos of articles offered for auction;
randomly displaying said plurality of videos via said auction site; and
allowing said prospective bidder to request further information about said article while an associated video is playing.

10. A computer implemented method of auctioning, said method comprising:
providing an auction site accessible via a computer network;
offering an article for auction via said auction site;
receiving from a seller of said article a video for said article;
providing access to said video via said auction site so as to enable a prospective bidder to access said video for viewing; and
soliciting feedback from said prospective bidder on said video.

11. The method as claimed in claim 10 and further comprising:
ranking the popularity of a plurality of product videos based on feedback from bidders.

12. The method as claimed in claim 11 and further comprising:
providing a list of the most popular videos for display via said auction site.

13. The method as claimed in claim 10 and further comprising:
compensating said seller of said article based upon how often said video is accessed.

14. A computer implemented method of auctioning, said method comprising:
providing an auction site accessible via a computer network;
offering an article for auction via said auction site;
receiving from a seller of said article a video for said article;
providing access to said video via said auction site so as to enable prospective bidder to access said video for viewing; and
configuring an icon as part of said auction site to allow said prospective bidder to conduct a video conference with said seller.

15. The method as claimed in claim 14 and further comprising:
receiving input via said auction site indicating that said icon has been selected by said prospective bidder; and
establishing a video conference between said prospective bidder and said seller.

16. The method as claimed in claim 15 and further comprising:
displaying said video conference as part of an auction site display.

17. The method as claimed in claim 14 and further comprising:
billing said seller of said article for said video conference.

18. The method as claimed in claim 14 and further comprising:
billing said potential bidder for said video conference.

19. The method as claimed in claim 14 and further comprising:
billing both said seller and said potential bidder for said video conference.
